(19) United States
(12) Patent Application Publication
(10) Pub. No.: US 2012/0124654 A1
(43) Pub. Date: May 17, 2012

(54) System and method for a secure user interface

(75) Inventor: Jean Luc Senac, Sao Paulo (BR)

(73) Assignee: Evolucard S/A

(21) Appl. No.: 13/200,417

(22) Filed: Sep. 22, 2011

Related U.S. Application Data
(60) Provisional application No. 61/458,085, filed on Nov. 16, 2010.

(51) Int. Cl. G06F 21/00; G06F 3/048; G06F 7/04

(52) U.S. Cl. 726/7

(57) ABSTRACT

In accordance with embodiments, there are provided mechanisms for methods and systems for inputting information, such as authentication and verification information, which are meant to thwart keylogging and phishing, while also assisting in a user's recall of the required input information. In at least one embodiment, a secure virtual keyboard is generated that has less buttons or entry keys than choices for input entry.

### CROSS REFERENCE TO RELATED APPLICATIONS

This application claims priority benefit of U.S. Provisional Patent Application No. 61/458,085 (Docket No. AI-2), entitled “METHOD AND SYSTEM FOR A SECURE VIRTUAL KEYBOARD”, by Jean Luc Senac, filed Nov. 16, 2010.

### FIELD OF THE INVENTION

The present specification relates to user interfaces that are used on electronic devices.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In order to access networked services, including Internet based services, such as financial institutions or online merchants, a user may be requested to pass through some form of authentication process to verify that the user is who the user claims to be. In other words, following the entry of a user identification (user ID), the user may be required to enter a personal identification number (PIN) or code to authenticate the user's identity. A PIN is a secret alphanumeric password shared between a user and a system that can be used to authenticate the user to the system. In systems where an access card with encoded data on a chip or magnetic strip is inserted in a card reader or interrogated wirelessly with radio frequency identification (RFID), a user may still be required to manually enter information to verify that access card is being used by an authorized user or owner of the access card. For example, automated teller machines (ATM) for carrying out financial transactions generally require a user to insert an access card into the ATM to initiate a session and the entry of an authenticating PIN to permit the execution of the financial transactions during the session. However, as consumers accumulate more and more access cards and accounts, the difficulty of remembering PIN increases.

User interfaces for implementing authentication processes can vary. Some examples of user interfaces may be a QWERTY keyboard, phone dial pad keyboard, ten key layouts, or any one of a variety of proprietary keyboard layouts. User interfaces can also be categorized by the way the interfaces are implemented as either physical or virtual. A physical interface keyboard or data entry device is an assembly made up of arrangement of interacting parts such as tactile keys for making selections that are attached to a transaction device or terminal in a wired or wireless manner, while a virtual interface or User Interface (UI) is displayed on a screen. UIs may allow for direct entry of values through the use of a touch screen, where the user directly touches the screen to select a value (i.e., letter, number, symbol, etc.), or through a pointing device controlled with a mouse or touch pad.

However, existing methods of user authentication and verification are susceptible to phishing and keylogging. Keylogging is a technological process of monitoring computer activity by recording, transmitting, and examining the characters typed on a computer keyboard. Employers monitoring employee productivity, typically involving clerical tasks sometimes use the keylogging technique. However keylogging programs may also involve be used for criminal activity, such as those embodied in spyware programs. Spyware programs attempt to gather confidential information, such as a text string including an account name and password, and particularly a text string of keyboard strokes following input of a particular web site address. For example, a mouse click on a web browser icon displays the configured home page. A keyboard is used to enter a secure banking web site universal resource locator (URL) in the address input box. Following that, an account number and password are keyed in to the respective input fields. A malicious spyware program records the keystrokes entered on the keyboard, and that sequence of keystrokes is sent to an unknown third party for possible fraudulent use. Keylogging programs, once installed and activated on a computer system, are extremely difficult to detect.

Keylogging programs generally work on the principle of detecting basic input/output system (BIOS) signals sent from what is assumed to be a standard keyboard layout (e.g., “QWERTY”, “DVORAK”, or other standard international keyboard layouts). Windows Vista and other popular operating systems and application software enable “re-mapping” of a computer keyboard. While this technique will thwart keyloggers, it is largely unused by the majority of computer users because the remapped keyboard departs from what is traditionally coordinated with the “muscle memory” of touch typists familiar with standard keyboard layouts. Other solutions to thwart keylogging involve displaying a keyboard on a monitor, from which input letters are selected with the mouse to enter the alphabetic and numeric characters in the input fields into the web form area that is used to contain the password. A variation of this method is to copy and paste the confidential information from a file. However, such approaches carry the risk of being defeated by hackers through the use of capturing and transmitting screen shots of completed forms, which are then analyzed for the confidential information. Therefore, an enhanced method and system to thwart keyloggers, while providing assistance to a user in remembering a PIN may be desirable.

### SUMMARY

In accordance with at least some embodiments, there are provided mechanisms for inputting information, such as authentication and verification information that are meant to thwart keylogging and phishing while assisting in a user's recall of the required input information. Some examples of devices may include a user device or terminal, a mobile device or terminal, a mobile phone, a laptop, handheld computer, computer pad (e.g., an Ipad®), another mobile device, personal computer, any device having a an input and a monitor or a screen, or any other device.

Each embodiment disclosed herein may be used or otherwise combined with any of the other embodiments disclosed. Any element of any embodiment may be used in any embodiment.

Any of the disclosed embodiments may be used alone or together with one another in any combination. The methods and systems encompassed within this specification may also include embodiments that are only partially mentioned or alluded to or are not mentioned or alluded to at all in this brief summary or in the abstract.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is an illustration of an embodiment of a secure User Interface (UI) using color association.

FIG. 2 is an illustration of an embodiment of an alternative configuration of a secure UI using color association.

FIG. 3 shows an illustration of an embodiment of a UI using arrow association.

FIG. 4 shows an illustration of an embodiment of a UI using image association.

FIG. 5 shows an illustration of an embodiment of a UI using equations to determine entries.

FIG. 6 shows an illustration of an embodiment of a UI using logical association.

FIG. 7 shows an illustration of an embodiment of a UI using both color and shape associations.

FIG. 8 shows an illustration of an embodiment of a PIN pad combined with a virtual mapping values based on language or letters.

FIG. 9 shows an illustration of an embodiment of a keyboard and monitor UI.

FIG. 10A is a flowchart of an embodiment of a server side method for implementing a UI.

FIG. 10B is a flowchart of an embodiment of a client side method for implementing a UI.

FIG. 11 is a block diagram of an embodiment of the components for implementing embodiments for UI verification.

FIG. 12 is a block diagram of an embodiment of a communication device for implementing embodiments of UIs.

FIG. 13 illustrates a block diagram of an embodiment of a system for implementing embodiments of devices configured with UIs.

FIG. 14 illustrates a flowchart of an embodiment of a method of using the environment of FIGS. 11-13.

FIG. 15 illustrates a flowchart of a method of making the environment of FIGS. 11-13.

### DETAILED DESCRIPTION

Although various embodiments of the invention may have been motivated by various deficiencies with the prior art, which may be discussed or alluded to in one or more places in the specification, embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

In accordance with embodiments, there are provided mechanisms for methods and systems for inputting information, such as authentication and verification information, which are meant to thwart keylogging and phishing, while also assisting in a user's recall of the required input information. In at least one embodiment, a secure User Interface (UI) is generated that has less buttons or entry keys than choices for input entry. The UI may include a virtual keyboard and/or virtual keypad. In other words, embodiments assign more than one unique entry variable to each input key, while providing a user with associations to determine which entry to input with each entry key that corresponds to the user's PIN or authentication code. In this specification, any place the term PIN is used a password, code, token, encryption key, or any other information that needs to be kept secured, which may be used for authentication, encryption, or verification, may be substituted. In at least some embodiments, the information that needs to be kept secured is known in advance to the user and already stored in a memory system of a server of an authentication system and/or a merchant at which the user has an account. In contrast to European Patent EP 1 599 786 1 entitled “Virtual Keyboard” issued on Nov. 29, 2006, at least some embodiments do not rely on the proximity of mapping values or characters to entry keys, but use the associations, which make entry more secure from visual spying, such as a person watching a user input their authentication and verification information, and/or form key logging. Associations employed in embodiments may include the use of colors, shadings, fill patterns, shapes, logical associations, mathematical computations, audio, etc.

At least one embodiment may be implemented with a UI that is displayed on a screen of a device. In embodiments, UIs may allow for direct entry of inputs through the use of a touch screen, where the user directly touches the screen to select a value (i.e., letter, number, symbol, etc.), or may select a value through a pointing device controlled with a mouse or touch pad. The virtual nature of the embodiments allows for the reconfiguration of the entry layouts and associations between user login sessions to further thwart keylogging, phishing, and other spying techniques. In at least one embodiment, the secure UI may be implemented through software and/or through hardware.

Various embodiments of a secure UI may be shown in any environment where there is an interaction between a user and a device, such as a computer, ATM, tablet computer, cellular phone, and/or any other device with a screen and input method. In at least one embodiment, the secure UI may consist of two or more buttons of any shape or color, where each button is associated to two or more values. In at least one embodiment, a value can be any number, alphanumeric, character, and/or other values. In at least one embodiment, on a platform where the input method is fixed, such as a physical keyboard or phone dial pad, the associations presented on the screen change with each login attempt or number of login attempts to provide greater security. In at least one embodiment, where the input method is variable, such as a touch screen device, both values of the keys and the associations can change. In at least one embodiment, the key layout may be changed over time (e.g., with every keystroke or switched whenever the user chooses). In order to make keyboards used in authentication processes more secure, security features may be integrated into the keyboards' designs. In the case of UIs this might mean shifting key layouts, non-numerical key associations or assigning multiple values to each key.

In at least one embodiment, the user is required to provide a non-confidential user identifier or token (the user ID) and a confidential PIN to gain access to the system using the UI. Upon receiving the user ID and PIN, the system looks up the PIN based upon the user ID and compares the looked-up PIN with the received PIN. The user is granted access only when the number entered matches with the number stored in the system. A temporary PIN may be assigned to a new user when a new account or access card is provided to a user. In an embodiment, the temporary PIN is mailed to the user in a separate envelope or email correspondence to avoid an unauthorized user from obtaining possession of both the access card and PIN to gain access to the authorized user's account. When the user logs on to their account for the first time with their access card or through entry of their user ID, the user enters the temporary PIN (which is recorded in the system) and is prompted to enter a new permanent PIN of their choice that has the number of alphanumeric character required by the system. In embodiments, the user may be asked to enter the new PIN again to confirm the user's choice of PIN. If the two entries of the new PIN match, the new permanent PIN is saved in the user's profile, and must be provide for future access to the user's account. In an embodiment, once the permanent PIN may be activated, and the temporary PIN may no longer valid to gain entry to the user's account. The permanent PIN may then be stored in a database as an authentication server and/or at the server of a merchant for later use in creating virtual keyboards having a different set of input and a mapping from the requested input to possible values for characters of the PIN.

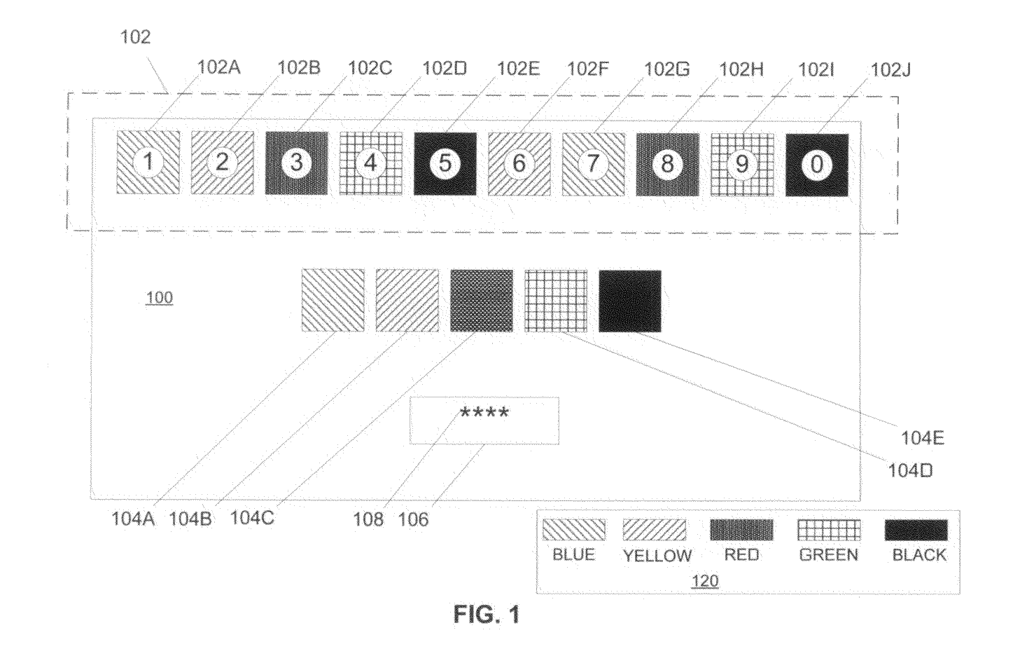

FIG. 1 is an illustration of a secure UI 100 using color association. The UI 100 may include mapping 102, mapping values 102A-102J, entry keys 104A-104E, entry area 106, and asterisks 108. FIG. 1 also shows figure-key 120. Figure-key 120 is not part of the user interface, and is provided to aid the reader in interpreting the rest of FIG. 1. In other embodiments, the secure UI 100 may not have all of the elements listed and/or may have other elements instead of or in addition to those listed.

Mapping 102 indicates to the user which entry key to select for a particular value of a key. Mapping 102 is a 2 to 1 mapping, which maps two candidates for one of the characters of the PIN to one entry key. Thus, whichever of the two values PIN characters is the next character of the PIN, the user selects the same entry key. Each of mapping values 102A-102J associates one possible value for a character of PIN with one possible entry key. In at least one embodiment of the secure UI 100 each of the mapping values 102A-102J may be associated with a color and a numerical value, thereby indicating the color of the entry key (which uniquely identifies the entry key) to select in order to select the desired numerical value of the PIN. The dashed lines surrounding mapping values 102A-102J indicates that mapping values 102A-102J collectively form mapping 102. For illustrative purposes of this disclosure, to avoid the complications of having the FIGs. printed in color, the colors (blue, yellow, red, green, and black) are represented by fill patterns having different cross hatchings. In the example of FIG. 1, two numeric values are associated with each color. In the example of FIG. 1, numeric values 1 (102A) and 7 (102G) are in blue squares, numeric values 2 (102B) and 6 (102F) are in yellow squares, numeric values 3 (102C) and 8 (102H) are in red squares, numeric values 4 (102D) and 9 (102I) are in green squares, and numeric values 5 (102E) and 0 (102J) are in black squares. The collection of mapping values 102A-102J constitutes a legend, which informs the user of a mapping between the values of the keys of a virtual keypad and the values of characters of the PIN. The user chooses the color to select on the virtual keypad based on the desired value to enter as indicated by mapping described by the collection of mapping values 102A-102J. Although throughout the specification a PIN is specified any personal or identifying information may be substituted for the PIN anywhere in the specification to obtain another embodiment. It is noted that other embodiments may have more than two values associated with a color and/or may be have fewer colors, more colors, and or different colors (in which each color may be associated with a different set of values). In an embodiment, colors with a high contrast for one another are chosen. Some examples of other colors that may be chosen are magenta, cyan, purple, aqua, lavender, orange, and brown. In an embodiment, each virtual entry key may be mapped to 3 mapping values, 4 mapping values, or 5 mapping values. In another embodiment, different entry keys of the same embodiment may be mapped to different numbers of mapping values. For example, one entry key may be mapped to just one mapping value and another entry key may be mapped to 5 mapping values. In other embodiments, instead of the mapping values being numbers, the mapping values may be other values, such as words, images, icons, letters, and/or chemical elements.

Entry keys 104A-104E are the virtual keys that are selected when the user would like to input the PIN. In this specification, the term “entry keys” refer to the keys identified by the mapping (e.g., mapping 101) that need to be selected in order to enter the PIN. If the mapping maps the set of symbols that make up the PIN to virtual keys that need to be selected, then the entry keys are the virtual keys, but if the mapping maps the set of symbols that make up the key to physical keys on a keyboard or keypad, then the entry keys are physical keys. Entry keys 104A-104E may be arranged in any color pattern. In the example shown in FIG. 1, the entry keys (which may also be referred to as virtual entry keys or virtual keys) are arranged as follows; blue (104A), yellow (104B), red (104C), green (104D), and black (104E). A valid color sequence for entry keys 104A-104E is based on the user's PIN or authentication and verification information as recorded in a secure device the user is trying to access. In other words, if the user would like to enter either of the values 1 or 7, the user selects the blue entry key 104A (as indicated by the 1 and the 7, mapping values 102A and 102G, being colored blue). If the user would like to enter either of the values 2 or 6, the user selects the yellow entry key 104B (as indicated by the 2 and the 6, mapping values 102B and 102F, being colored yellow). If the user would like to enter either of the values 3 or 8, the user selects the blue virtual entry key 104C (as indicated by the 3 and the 8, mapping values 102C and 102H, being colored red). If the user would like to enter either of the values 4 or 9, the user selects the green entry key 104D (as indicated by the 4 and the 9, mapping values 102D and 102I, being colored green). If the user would like to enter either of the values 5 or 0, the user selects the back entry key 104E (as indicated by the 5 and the 0, mapping values 102E and 102J, being colored black).

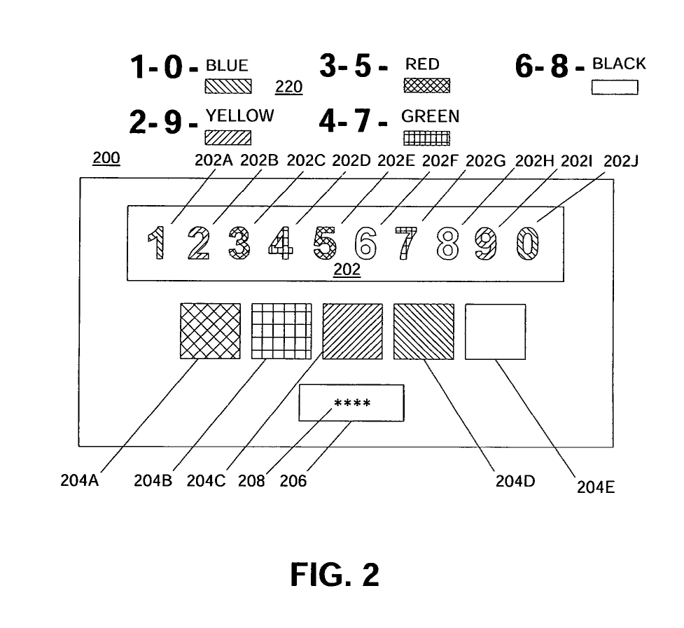

For example, if the user's PIN is 0824, since the digit 0 is colored black (as indicted by mapping value 102J), the digit 8 is colored red (as indicated by mapping value 102H), the digit 2 is colored yellow (as indicted by mapping value 102B), and the digit 4 is colored green (as indicted by mapping value 102D), the user selects the sequence of entry keys—black (entry key 104E), red (entry key 104C), yellow (entry key 104B), and green (entry key 104E) as the input. In other embodiments entry keys 104A-104E may have other distinguishing characteristics, such as each of the entry keys 104A-104E may be a different shape, may have a different label (such as a letter or a name), and/or each of virtual entry keys 104A-104E may have a different pattern or texture. In an embodiment, instead of each of entry keys 104A-104E being a different color each may be a different category, and each mapping values 102A-102J may be different values that fit into one of the categories of entry keys 104A-104E (see FIGS. 2-9 for other variations of the embodiment of FIG. 1).

In an embodiment, any portion of UI 100, such as entry keys 104A-104E may first be displayed following the insertion of an access card and/or entry of a user name and/or user ID. The user enters their PIN, which may be one of several combinations based on the fact that more than one value is assigned to each of entry keys 104A-104E. If a sequence of entry keys 104A-104E corresponding to a valid sequence of mapping values 102A-102J, such as blue (104A), yellow (104B), red (104C), green (104D), black (104E) in order to select 7 (102G), 2 (102B), 8 (102H), 4 (102D), and 0 (102J) matches the stored pin, the user is granted access to the system. However, if the entered sequence of virtual entry keys 104A-104E (such as blue, green, yellow, green, red instead of blue, yellow, red, green, black) does not have a combination of mapping values as indicated by mapping values 102A-102J that matches the stored PIN, access is denied to the user. Entry area 106 shows the number of entries entered so far (in the example of FIG. 1 four entries are shown as having been entered), which are indicated by displaying individual asterisks 108 for each entry value. Asterisks 108 hide the actual value of the entry. Figure-key 120 indicates which crosshatchings or fill patterns in FIG. 1 are being used to represent which colors.

FIG. 2 is an illustration of an alternative configuration of a secure UI 200 using color association, where the mapping values or characters themselves have colors. The UI 200 may include mapping 202, mapping values 202A-202J, entry keys 204A-204E, entry area 206, and asterisks 208. FIG. 2 also shows figure-key 220. Figure-key 220 is not part of the user interface, and is provided to aid the reader in interpreting the rest of FIG. 2. In other embodiments, the secure UI 200 may not have all of the elements listed and/or may have other elements instead of or in addition to those listed.

Mapping 202 indicates to the user which entry key to select for a particular value of a key. Mapping 202 is a 2 to 1 mapping, which maps two candidates for one of the characters of the PIN to one entry key. Thus, whichever of the two values PIN characters is the next character of the PIN, the user selects the same entry key. Each of mapping values 202A-202J associates one possible value for a character of PIN with one possible entry key. In at least one embodiment of the secure UI 200 each of the mapping values 202A-202J may be associated with a colored number. Mapping values 202A-202J collectively form mapping 202. The numerical values of each of mapping values 202A-202J indicates a possible numerical value of a PIN, and the color of each colored number of mapping values 202A-202J indicates the color of the entry key (which uniquely identifies the entry key) to select in order to select the desired numerical value of the PIN, which is the numerical value of the colored number. By using colored numbers, each of the mapping values 202A-202J may not only be associated with a color, but the mapping values 202A-202J may also be displayed in the colors of the entry keys 204A-204E, which for illustrative purposes of this disclosure the colors (blue, yellow, red, green, black) are represented by different cross hatching patterns. UI 200 functions in the same way as UI 100, except that to indicate the mapping between the numbers and the colors, the numbers are colored instead of coloring a fill areas in a symbol within which the number is located. As in the example of FIG. 1, in the example of FIG. 2, two numeric values are associated with each color. In the embodiment of FIG. 2, numeric values 1 (202A) and 0 (202J) are displayed in blue, numeric values 2 (202B) and 9 (202I) are displayed in yellow, numeric values 3 (202C) and 5 (202E) are displayed in red, numeric values 4 (202D) and 7 (202G) are displayed in green, and numeric values 6 (202F) and 8 (202H) are displayed in black. It is noted that, as in the example of FIG. 1, other embodiments may have more than two values associated with a color. Entry keys 204A-204E may be arranged in any color pattern, and in the example shown in FIG. 2 the entry keys are arranged as follows green (204A), red (204B), yellow (204C), blue (204D), and black (204E). A valid color sequence for entry keys 204A-204E is based on the user's PIN or authentication and verification information as recorded in a secure device the user is trying to access. As in the example of FIG. 1, the entry keys 204A-204E may be displayed following the insertion of an access card, and/or entry of a user name or user ID. In an embodiment, the user enters their PIN by selecting a sequence of virtual keys 204A-204E, which may be equivalent to one of several combinations of mapping values 202A-202J, based on the fact that more than one value is assigned to each entry key 204A-204E. If a valid sequence of virtual keys 204A-204E is entered such as red (204B), yellow (204C), green 204A, black 204E, green 204A that corresponds to a numeric sequence 5 (202E), 9 (202I), 4 (202A), 6 (202F), and 7 (202G) that matches the stored pin, the user is granted access to the system. However, if the entered sequence of entry keys 204A-204E does not have a corresponding sequence of entry keys 202A-202J that match the stored PIN, access is denied to the user. As was described in FIG. 1 for entry area 106, entry area 206 shows the number of entries so far (three as shown) that have been entered by the user with the asterisks 208. The asterisks 208 hide the actual value of the entry.

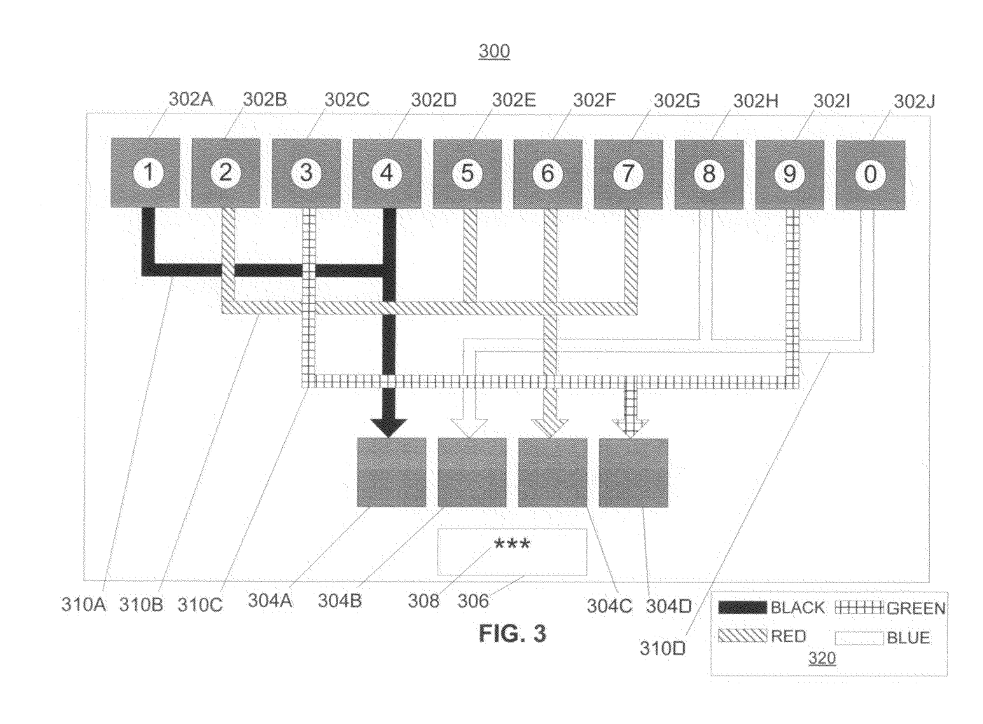

FIG. 3 shows an illustration of a UI 300 using an arrow association between mapping values 302A-302J and entry keys 304A-304D. The UI 300 may include mapping values 302A-302J, entry keys 304A-304D, entry area 306, asterisks 308, and colored connector lines 310A-310D. FIG. 3 also shows figure-key 320. Figure-key 320 is not part of the user interface, and is provided to aid the reader in interpreting the rest of FIG. 3. In other embodiments, the secure UI 300 may not have all of the elements listed and/or may have other elements instead of or in addition to those listed.

Each of mapping values 302A-302J is one possible character of the user's PIN. In at least one embodiment of the secure UI 300 each of the mapping values 302A-302J may be associated with the entry keys 304A-304D via colored connector lines 310A-310D, thereby indicating the entry key to select in order to select the desired value of the next entry of the PIN. In an embodiment, each of colored connector lines 310A-310D is a colored arrow with two tails and one head. Each of colored connector lines 310A-310D points from two of mapping values 302A-302J (which are two possible PIN character) to one of entry keys 304A-304D, indicating that to enter the PIN character the user need to select the entry key that is connected to that PIN character by one of connector lines 310A-310D. The coloring of connector lines 310A-310D is optional. Optionally, mapping values 301A-302J and/or entry keys 304A-304D may have the same fill colors and/or font colors as the connector lines to which each is connected. Optionally, that pair of mapping values 301A-302J that joined by same one of connector lines 310A-310D to one of entry keys 304A-304D may have the same fill colors, font colors, and/or may be associated with the same shape. In an embodiment, instead of one arrow with two tails there are two connector lines of each color, which both point to the same one of entry keys 304A-304D. UI 300 functions in the same way as UIs 100 and 200, except that the colored connector lines 310A-310D show the correspondence between the virtual keys and the mapping values in addition to, or instead of, coloring the numbers and/or the fill areas behind the numbers.

The colored connector lines 310A-310D, which for illustrative purposes of this disclosure the colors (blue, red, green, black) are represented by different fill patterns within the colored connector lines 310A-310D. In the example of FIG. 3, various differing amounts of mapping values from 302A-302J are assigned to each of the entry keys 304A-304D via colored connector lines 310A-310D. In the embodiment of FIG. 3, numeric values 1 (302A) and 4 (302D) are connected with black colored connector line 310A to entry key 304A, numeric values 2 (302B), 5 (302E), 6 (302F), and 7 (302G) are connected with red colored connector line 310B to entry key 304C, numeric values 3 (302C) and 9 (302I) are connected with green colored connector line 310C to entry key 304D, and numeric values 8 (302H) and 4 (302J) are connected with blue colored connector line 310D to entry key 304B. It is noted that in other embodiments, colored connector lines 310A-310D may have different routings between the mapping values 302A-302J and entry keys 304A-304D. Although entry keys 304A-304D are illustrated as not having any distinguishing features other than which of colored connector lines 310A-310D connects to each one, other distinguishing features may be added. For example each of entry keys 304A-304D may have a different color, shape, and/or label. In addition, the number of mapping values, entry keys, and connector lines may vary between embodiments. A valid routing sequence for the colored connector lines 310A-310D is based on the user's PIN or authentication and verification information as recorded in a secure device the user is trying to access. The colored connector lines 310A-310D may be displayed following the insertion of an access card, and/or entry of a user name or user ID. The user enters their PIN, which may be one of several combinations based on the fact that more than one value is assigned to each entry key 304A-304D. If a valid sequence of entry keys 304A-304D are selected such as 304B, 304A, 304D, and 304C so that a corresponding sequence of mapping values such as for example 8 (302H), 4 (302D), 3 (302C), and 6 (302F) matches the stored pin, the user is granted access to the system. However, if the entered sequence of entry keys 304A-304D does not correspond to a valid sequence of mapping values that matches the stored PIN, access is denied to the user. The description of entry area 306 and asterisk 308 is essentially the same as entry area 106 and asterisk 108, and therefore will not be repeated. Figure-key 320 indicates which crosshatchings or fill patterns in FIG. 3 are being used to represent which colors.

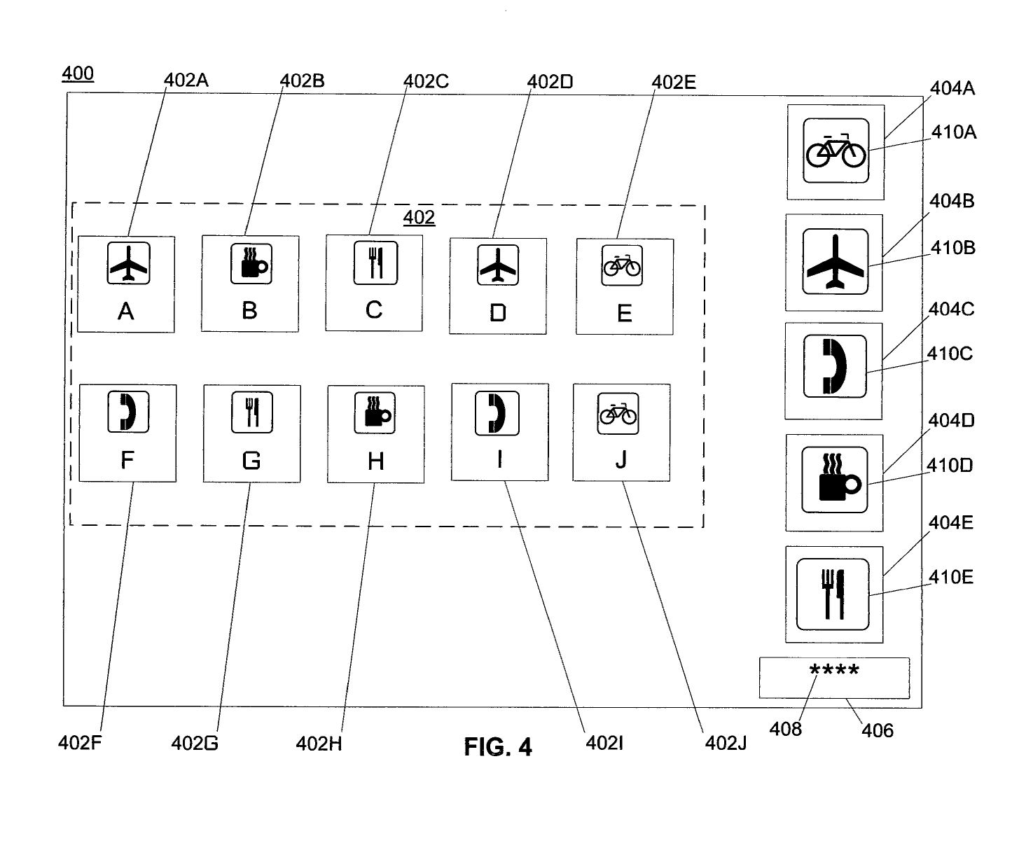

FIG. 4 shows an illustration of a UI 400 using image association between mapping values 402A-402J and entry keys 404A-404E. The UI 400 may include mapping 402, mapping values 402A-402J, entry keys 404A-404E, entry area 406, asterisks 408, and symbols 410A-410E. In other embodiments, the secure UI 400 may not have all of the elements listed and/or may have other elements instead of or in addition to those listed.

Mapping 402 indicates to the user which entry key to select for a particular value of a character of a PIN. Mapping 402 may be a 2 to 1 mapping, which maps two candidates for one of the characters of the PIN to one entry key. Thus, whichever of the two values of the PIN characters is the next character of the PIN, the user selects the same entry key. Each of mapping values 402A-402J associates one possible value for a character of PIN with one possible entry key. In at least one embodiment of the secure UI 400, each of the mapping values 402A-402J includes a possible alphabetical value of a PIN and a symbol of and entry key, thereby indicating the symbol of the entry key (which uniquely identifies the entry key) to select in order to select the desired alphabetical value of the PIN. The dashed lines surrounding mapping values 202A-202J indicates that mapping values 402A-402J collectively form mapping 402. Each of the mapping values 402A-402J may be associated with the entry keys 404A-404E via the matching of a set of symbols 410A-410E that are assigned to both the mapping values 402A-402J and entry keys 404A-404E. The symbols 410A-410E, which for illustrative purposes of this disclosure are service symbols such as transportation (bicycle (410A), airport (410B)), communications (phone (410C)), and food (mug (410D), utensils (410E)). It is noted that in other embodiments different symbols and the ordering and assignments of the symbols may change. In addition, the number of mapping values and entry keys may vary between embodiments. UI 400 functions in the same way as UI 100, except that symbols are used instead of colors. As in the example of FIG. 1, in the example of FIG. 4, two mapping values, which in the present example are letters from mapping values 402A-402J, are assigned to each of the entry keys 404A-404E via the matching of symbols 410A-410E. In the embodiment of FIG. 4, letters E (402E) and J (402J) are a match to entry key 404A using symbol 410A, letters A (402A) and D (402D) are a match to entry key 404B using symbol 410B, letters F (402F) and I (402I) are a match to entry key 404C using symbol 410C, letters B (402B) and H (402H) are a match to entry key 404D using symbol 410D, and letters C (402C) and G (402G) are a match to entry key 404E using symbol 410E. A valid matching sequence between each of the mapping values 402A-402J and the entry keys 404A-404E is based on the user's PIN or authentication and verification information as recorded in a secure device the user is trying to access. In other embodiments, mapping values 402A-402J may use other values instead of or in addition to letters, such as numbers, words, other symbols, words, colors, and/or pictures. The mapping values 402A-402J, entry keys 404A-404E, and matching symbols 410A-410E may be displayed following the insertion of an access card, and/or entry of a user name or user ID. The user enters their PIN, which may be one of several combinations based on the fact that more than one value is assigned to each entry key 404A-404E. If a valid sequence of entry keys 404A-404E, for example 404B, 404A, 404C, 404E, and 404D are selected such that a corresponding sequence of mapping values such as for example A (402A), E (402E), I (402I), C (402C), and B (402B) matches the stored pin, the user is granted access to the system. However, if the entered sequence of entry keys 404A-404E does not correspond to a valid sequence of mapping values that matches the stored PIN, access is denied to the user. The description of entry area 406 and asterisk 408 is essentially the same as entry area 106 and asterisk 108, and therefore will not be repeated.

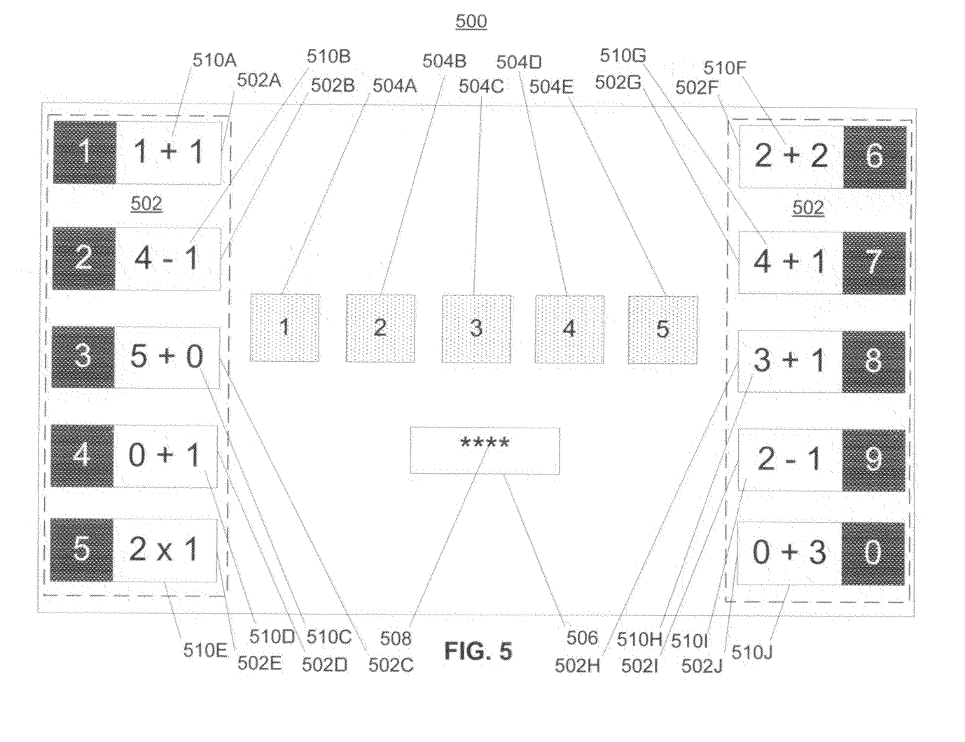

FIG. 5 shows an illustration of a UI 500 using equations 510A-510J to determine relationships between mapping values 502A-502J and entry keys 504A-504E. The UI 500 may include mapping 502, mapping values 502A-502J, entry keys 504A-504E, entry area 506, asterisks 508, and assigning equations 510A-510J. In other embodiments, the secure UI 500 may not have all of the elements listed and/or may have other elements instead of or in addition to those listed.

Mapping 502 indicates to the user which entry key to select for a particular value of a character of a PIN. Mapping 502 may be a 2 to 1 mapping, which maps two candidates for one of the characters of the PIN to one entry key. Thus, whichever of the two values of the PIN characters is the next character of the PIN, the user selects the same entry key. Each of mapping values 502A-502J associates one possible value for a character of PIN with one possible entry key. In at least one embodiment of the secure UI 500 each of the mapping values 502A-502J may be associated with the entry keys 504A-504E via the solving and matching of a set of equations 510A-510E that are assigned to the mapping values 502A-502J. In an embodiment, entry keys 504A-504E may be replaced with physical key (instead of being virtual keys). Mapping values 502A-502J each include a possible numerical value of a PIN and an equation whose solution is the value of an entry key, thereby indicating the symbol of the entry key (which uniquely identifies the entry key) to select in order to select the desired numerical value of the PIN. The dashed lines surrounding the two groups of mapping values 502A-502J indicates that mapping values 502A-502J collectively form mapping 502. The solving of the mathematical equations 510A-510E provides values that are associated with entry keys 504A-504E. In other words, if the user wants to select a particular digit that makes up the code, the user finds that digit/mapping value in the set of mapping values 502A-502J, determines the solution to the math equation adjacent to mapping value/digit, and then finds which of virtual keys 504A-504E has the solution to the equation. It is noted that in other embodiments different equations and the ordering and assignments of the equations may change. In addition, the number of mapping values and entry keys may vary between embodiments. UI 500 functions in the same way as UI 100, except that mathematical equations are used instead of colors for associating mapping values with virtual keys. As in the example of FIG. 1, in the example of FIG. 5, two mapping values, which in the present example are the digits 0 through 9 as shown in the shaded region of the mapping values 502A-502J, are assigned to each of the entry keys 504A-504E via the solving of assigning equations 510A-510J. In the embodiment of FIG. 5, digit 4 (502D) which has a solved equation value of 0+1=1 (510D) and digit 9 (502I) which also has a solved equation value of 2−1=1 (510D) are matched to entry key 504A by the solution value of 1. Similarly, digit 1 (502A) which has a solved equation value of 1+1=2 (510A), and digit 5 (502E) which also has a solved equation value of 2×1=2 (510E), are matched to entry key 504B by the solution value of 2. Likewise, digit 2 (502B), which has a solved equation value of 4−1=3 (510B), and digit 0 (502J) which also has a solved equation value of 0+3=3 (510J), are matched to entry key 504C by the solution value of 3. Also, digit 6 (502F), which has a solved equation value of 2+2=4 (510F), and digit 8 (502H), which also has a solved equation value of 3+1=4 (510H) are matched to entry key 504D by the solution value of 4. Finally, digit 3 (502C), which has a solved equation value of 5+0=5 (510C), and digit 7 (502G) which also has a solved equation value of 4+1=5 (510G), are matched to entry key 504E by the solution value of 5. A valid matching sequence between each of the mapping values 502A-502J and the entry keys 504A-504E is based on the user's PIN or authentication and verification information as recorded in a secure device the user is trying to access. The mapping values 502A-502J, entry keys 504A-504E, and assigning equations 510A-510J may be displayed following the insertion of an access card, and/or entry of a user name or user ID. The user enters their PIN, which may be one of several combinations based on the fact that more than one value is assigned to each entry key 504A-504E. If a valid sequence such as 4 (502D), 1 (502A), 0 (502J), 8 (502H), and 3 (502C) matches the stored pin, the user is granted access to the system. However, if the entered sequence (such as 9, 1, 0, 8, 3) does not match the stored PIN, access is denied to the user. The description of entry area 506 and asterisk 508 is essentially the same as entry area 106 and asterisk 108, and therefore will not be repeated.

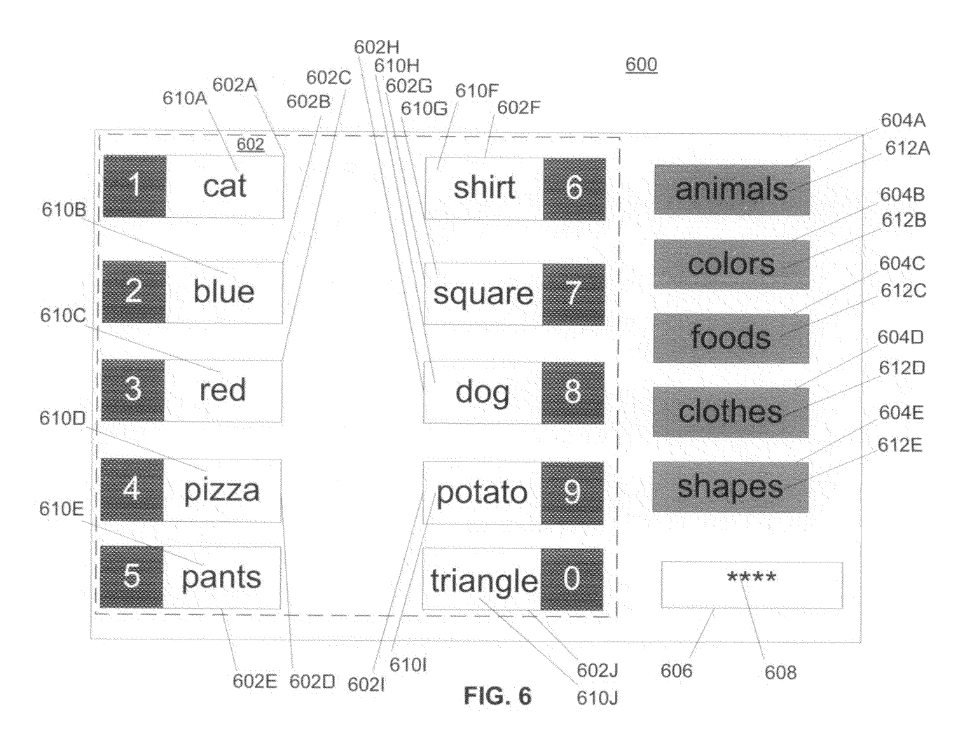

FIG. 6 shows an illustration of a UI 600 using logical association between mapping values 602A-602J and entry keys 604A-604E. The UI 600 may include mapping 602, mapping values 602A-602J, entry keys 604A-604E, entry area 606, asterisks 608, words 610A-610E, and categories 612A-612E. In other embodiments, the secure UI 600 may not have all of the elements listed and/or may have other elements instead of or in addition to those listed.

Mapping 602 indicates to the user which entry key to select for a particular value of a character of a PIN. Mapping 602 may be a 2 to 1 mapping, which maps two candidates for one of the characters of the PIN to one entry key. Thus, whichever of the two values of the PIN characters is the next character of the PIN, the user selects the same entry key. Each of mapping values 602A-602J associates one possible value for a character of PIN with one possible entry key. In at least one embodiment of the secure UI 600 each of the mapping values 602A-602J may be associated with the entry keys 604A-604E via the logical association between a set of words 610A-610J that are assigned to the mapping values 602A-602J and categories 612A-612E assigned to entry keys 604A-604E. Mapping values 602A-602J each include a possible numerical value of a PIN and a word that belongs to one of several categories, thereby indicating the category on the entry key (which uniquely identifies the entry key) to select in order to select the desired numerical value of the PIN. The dashed lines surrounding mapping values 602A-602J indicates that mapping values 602A-602J collectively form mapping 602. The categories 612A-612E, which for illustrative purposes of this disclosure are animals (612A), colors (612B), foods (612C), clothes (612D), and shapes (612E)). It is noted that in other embodiments different categories, words and the ordering and assignments of the categories and words may change. In addition, the number of mapping values and entry keys may vary between embodiments. UI 600 functions in the same way as UI 100, except that categories are used instead of colors. As in the example of FIG. 1, in the example of FIG. 6, two mapping values, which in the present example are numbers from 602A-602J, are assigned to each of the entry keys 604A-604E via the logical association of words 610A-610J to categories 612A-612E. In the embodiment of FIG. 6, digits 1 (602A) (which is associated with a cat, which is an animal) and 8 (602H) (which is associated with a dog, which is also an animal) are a match to entry key 604A for the category 612A (which is the category animals). Similarly digits 2 (602B) (which is associated with blue, which is a color) and 3 (602C) (which is associated with red, which is also a color) are a match to entry key 604B for the category 612B (which is the category colors). Likewise, digits 4 (602D) (which is associated with pizza, which is a food) and 9 (602I) (which is associated with patato, which is a food) are a match to entry key 604C for the category 612C (which is a category foods). Digits 5 (602E) (which is associated with pants, which are clothing) and 6 (602F) (which is associated with shirts, which are also clothing) are a match to entry key 604D for the category 612D (which is the category clothes). Finally, digits 7 (602H) (which is associated with the shape square) and 0 (602J) (which is associated with the shape triangle) are a match to entry key 604E for the category 612E (which is the category shapes). A valid matching sequence between each of the mapping values 602A-602J and the entry keys 604A-604E is based on the user's PIN or authentication and verification information as recorded in a secure device the user is trying to access. The mapping values 602A-602J, entry keys 604A-604E, words 610A-610E, and categories 612A-612E may be displayed following the insertion of an access card, and/or entry of a user name or user ID. The user enters their PIN, which may be one of several combinations based on the fact that more than one value is assigned to each entry key 604A-604E. If a valid sequence of entry keys 604A-604E such as color (604B), animals (604A), foods (604C), clothes (604D, and shapes (604E) corresponding to mapping values 2 (602B), 1 (602A), 4 (602D), 5 (602E), and 7 (602G) matches the stored pin, the user is granted access to the system. However, if the entered sequence of entry keys 640A-604E does correspond to a sequence of mapping values 602A-602J that matches the stored PIN, access is denied to the user. The description of entry area 606 and asterisk 608 is essentially the same as entry area 106 and asterisk 108, and therefore will not be repeated.

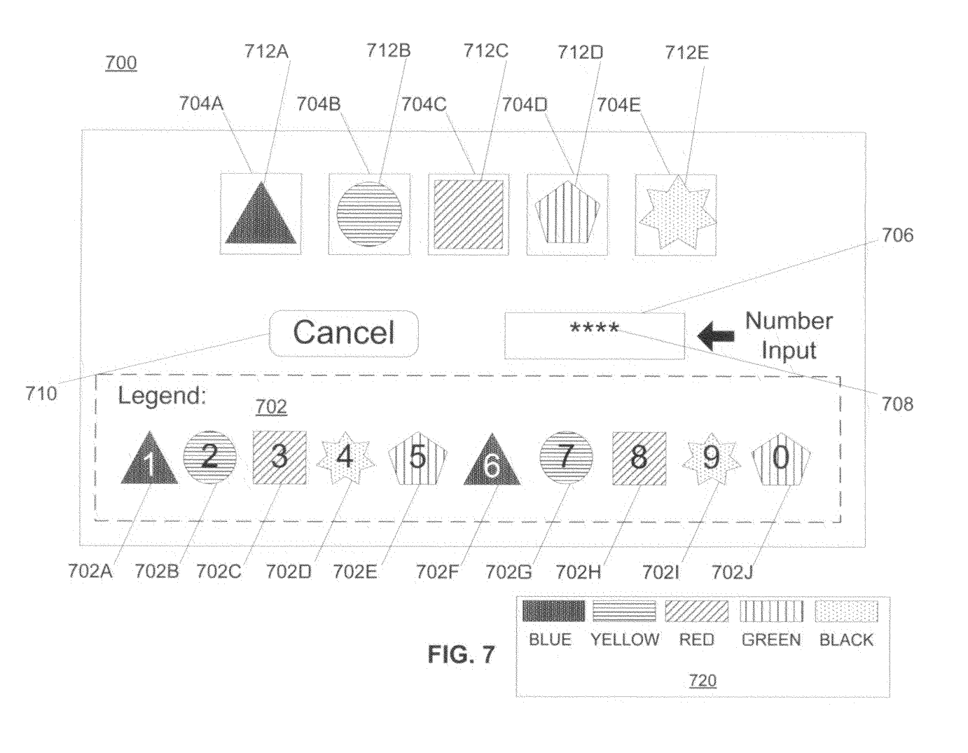

FIG. 7 is an illustration of an alternative configuration of a secure UI 700 using both shape and color to establish associations between mapping values 702A-702J and the entry keys 704A-704E. The UI 700 may include mapping 702, mapping values 702A-702J, entry keys 704A-704E, entry area 706, asterisks 708, cancel button 710, and entry shapes 712A-712E. FIG. 7 also shows figure-key 720. Figure-key 720 is not part of the user interface, and is provided to aid the reader in interpreting the rest of FIG. 7. In other embodiments, the secure UI 700 may not have all of the elements listed and/or may have other elements instead of or in addition to those listed.

Mapping 702 indicates to the user which entry key to select for a particular value of a character of a PIN. Mapping 702 may be a 2 to 1 mapping, which maps two candidates for one of the characters of the PIN to one entry key. Thus, whichever of the two values of the PIN characters is the next character of the PIN, the user selects the same entry key. Each of mapping values 702A-702J associates one possible value for a character of PIN with one possible entry key. In at least one embodiment of the secure UI 700 each of the mapping values 702A-702J may not only be associated with a color, but the mapping values 702A-702J may also be displayed in the colored shape 712A-712E of the entry keys 704A-704E, which for illustrative purposes of this disclosure the colors (blue, yellow, red, green, black) are represented by different fill patterns. Mapping values 702A-702J each include a possible numerical value of a PIN inside a colored shape, thereby indicating the symbol of the entry key (which uniquely identifies the entry key) to select in order to select the desired numerical value of the PIN. The dashed lines surrounding the mapping values 702A-702J indicates that mapping values 702A-702J collectively form mapping 702. UI 700 functions in the same way as UI 100, except that shapes and colors are used instead of just colors. As in the example of FIG. 1, in the example of FIG. 7, two numeric values are associated with each color. In the embodiment of FIG. 7, numeric values 1 (702A) and 6 (702F) are displayed in a blue triangle, numeric values 2 (702B) and 7 (702G) are displayed in a yellow circle, numeric values 3 (702C) and 8 (702H) are displayed in a red square, numeric values 4 (702D) and 9 (702I) are displayed in a black star, and numeric values 5 (702F) and 8 (702J) are displayed in green pentagon. It is noted that other embodiments may have more than two values associated with a colored shape, and the colors and shapes may be different. Entry keys 704A-704E may be arranged in any color pattern, and in the example shown in FIG. 7 the entry keys are arranged as follows blue (704A), yellow (704B), red (704C), green (704D), and black (704E). A valid color sequence for entry keys 704A-704E may be based on the user's PIN or authentication and verification information as recorded in a secure device the user is trying to access. The entry keys 704A-704E may be displayed following the insertion of an access card, and/or entry of a user name or user ID. The user enters their PIN, which may be one of several combinations based on the fact that more than one value is assigned to each entry key 704A-704E. If a valid sequence of entry keys 704A-704E are entered such as yellow circle (704B), blue triangle (704A), red square (704C), green pentagon (704D), and black star 704E, which corresponds to mapping values 7 (702G), 1 (702A), 3 (702C), 0 (702J), and 9 (702I) matches the stored pin, the user is granted access to the system. However, if the entered sequence of entry keys 704A-704E does not correspond to a sequence of mapping values 702A-702J that match the stored PIN, access is denied to the user. The description of entry area 706 and asterisk 708 is essentially the same as entry area 106 and asterisk 108, and therefore will not be repeated. The cancel button 710 may be configured to cancel all entries entered so far (four as shown), or only the last digit entered, with further entered digits eliminated for each cancel button 710 selection. Cancel button 710 is optional. Figure-key 720 indicates which crosshatchings or fill patterns in FIG. 7 are being used to represent which colors.

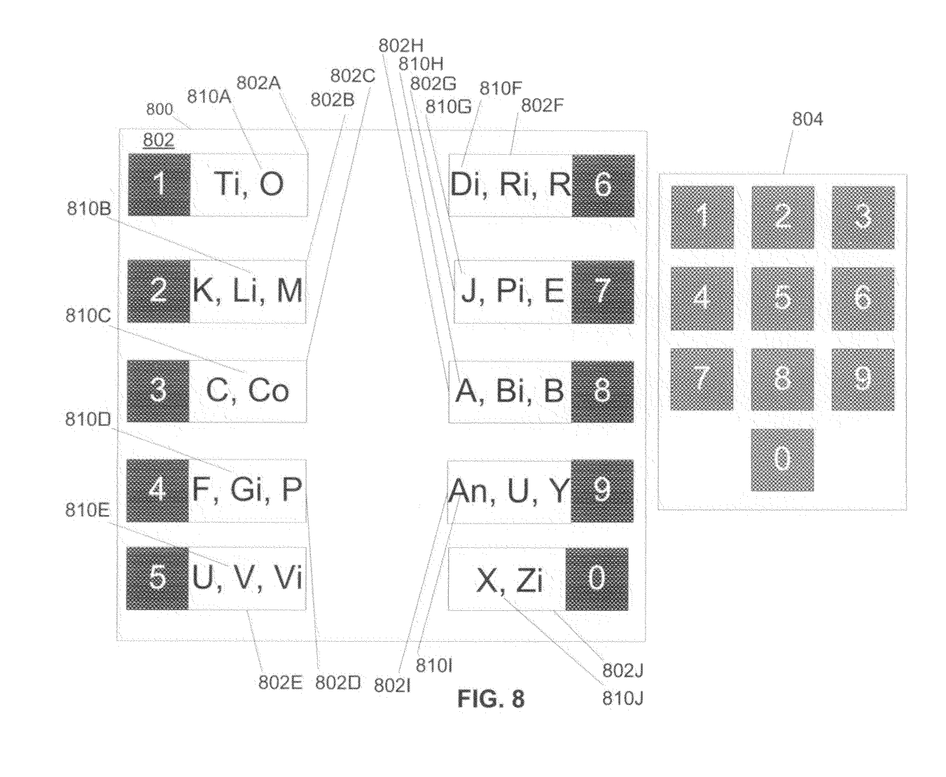

FIG. 8 shows an illustration of a numeric keypad 804 combined with a UI 800 with mapping values based on language or letter combinations. The UI 800 may include mapping 802, input numeric values 802A-802J, and letter combinations 810A-810J. In other embodiments, the secure UI 800 may not have all of the elements listed and/or may have other elements instead of or in addition to those listed.

Mapping 802 indicates to the user which entry key to select for a particular value of a character of a PIN. Mapping 802 is a many to one mapping that may include a 2 to 1 mappings, some 3 to 1 mappings and some 3-2 mapping, which maps two candidates for one of the characters of the PIN to one entry key. Thus, whichever of the two values of the PIN characters is the next character of the PIN, the user selects the same entry key. Each of mapping values 802A-802J associates two or three possible value for a character of PIN with one possible entry key. UI 800 functions in the same way as UI 100, except that the password is a sequence of combinations of letters instead of numbers, and the virtual keys are numbers instead of colors. Mapping values 802A-802J each include several possible alphabetical values of a PIN in which each alphabetical value may include multiple letters and one value of an entry key, thereby indicating the symbol of the entry key (which uniquely identifies the entry key) to select in order to select the desired alphabetical value of the PIN. Mapping values 802A-802J collectively form mapping 802. In at least one embodiment of the secure UI 800 each of the input numeric values 802A-802J may be associated with letters or combination of letters in a password via letter combinations 810A-810J. The input numeric values 802A-802J are entered with the numeric keypad 804 in the corresponding sequence to the users password or letter combination. Numeric keypad 804 may be a virtual or physical keypad. For example, the password may be a sequence of letter combinations 810A-810J, which are selected by selecting of the numeric keys of numeric keypad 804. In an embodiment each combination of letter combinations 810A-810J is at least one capital letter optionally followed by one or more lower case letters. For example, if the user chooses TiOJA as the password, the use selects Ti, by selecting the key for digit 1 from numeric key pad 804, then the user selects O by selecting the key for digit 1, again, from numeric keypad 804, then the user selects J by selecting the key for digit 7 from and keypad 804, and finally the user selects the letter A by selecting the key for digit 8 from numeric keypad 804. It is noted that in other embodiments different letter and letter combinations and the ordering and assignments of the letters and letter combinations may change. In addition, the number of mapping values and entry keys may vary between embodiments. A valid matching sequence between each of the mapping values 802A-802J and the numeric keypad 804 may be based on the user's authentication and verification information as recorded in a secure device the user is trying to access. The input numeric values 802A-802J and letter combinations 810A-810J may be displayed following the insertion of an access card, or entry of a user name or user ID. If for example, a user has a password of “FAME”, the numeric entry in the keypad 804 of 4 (802D), 8 (802H), 2 (802B), 7 (802G) as a valid sequence grants the user access to the system. However, if the entered sequence does not match the stored password, access is denied to the user.

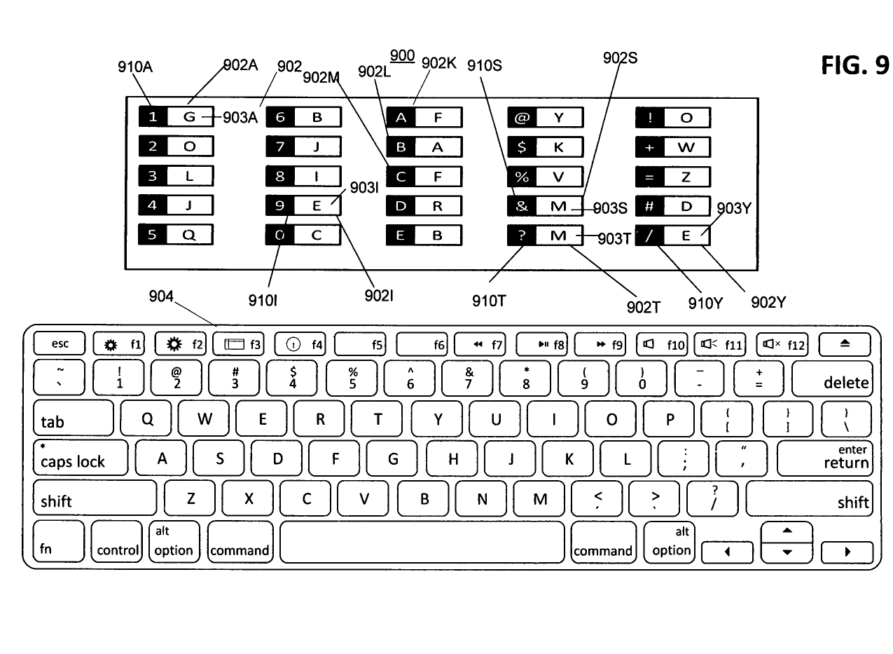

FIG. 9 shows an illustration of a physical keyboard 904 and monitor UI 900. The UI 900 may include mapping 902 having mapping values 902A-902Y, keyboard values 903A-903Y, keyboard 904, and PIN values 910A-910Y. In other embodiments, the secure UI 900 may not have all of the elements listed and/or may have other elements instead of or in addition to those listed.

Mapping 902 indicates to the user which entry key to select for a particular value of a character of a PIN. Mapping 902 may include some 2 to 1 mappings and some 1 to 1 mappings, which maps two candidates for one of the characters of the PIN to one entry key. Thus, whichever of the two values of the PIN characters is the next character of the PIN, the user selects the same entry key. Each of mapping values 902A-902J associates one possible value for a character of PIN with one possible entry key. UI 900 functions in the same way as UI 100. Mapping 902 is a table that indicates a mapping between PIN values and keys on a physical or virtual keyboard. Mapping values 902A-902Y each include a possible alphabetical value of a PIN and the value of an entry key, thereby indicating the symbol of the entry key (which uniquely identifies the entry key) to select in order to select the desired alphanumerical value of the PIN. Mapping values 902A-902Y collectively form mapping 902. Mapping values 903A-903Y indicate the values on the keyboard 904. If keyboard 904 is a physical keyboard, keyboard 904 may be a wired or wireless keyboard. PIN values 910A-910Y are the values from which the characters of the PIN are chosen and mapping values 902A-902Y indicate the key on the keyboard 904 to select for a desired one PIN values 910A-910Y. Each of mapping values 902A-902Y, includes one of PIN values 910A-910Y and one of keyboard values 903A-903Y. Keyboard 904 may be a physical or a virtual keyboard. Keyboard values 910A-910Y and correspond to the labels on the keys of the keyboard 904 that are selected in order to select a particular PIN value. For example, if the user's PIN is /, &, B, and A, the user is informed through the UI 900 that to indicate the user's PIN (/, &, B, A) on keyboard 904, and the user needs to select “E” (902Y) for “/” (910Y), to select “M” (902S) for “&” (910S), to select “A” (902L) for “B” (910L), and to select “F” (902K) for “A” (910K). In an embodiment, a sequence of entries or mapping 902 is created on the UI 900 in response to the insertion of an access card, and/or entry of a user name or user ID. The user, following the mapping 902 enters a PIN or password using the physical table 904. A valid entry sequence of a PIN or password grants the user access to the system. However, if the entered sequence does not match the stored password, access is denied to the user. It is noted that in other embodiments different combinations and formats of the mapping 902 may be generated on the UI 900. The combinations and formats of the mapping 902 may change between each login session.

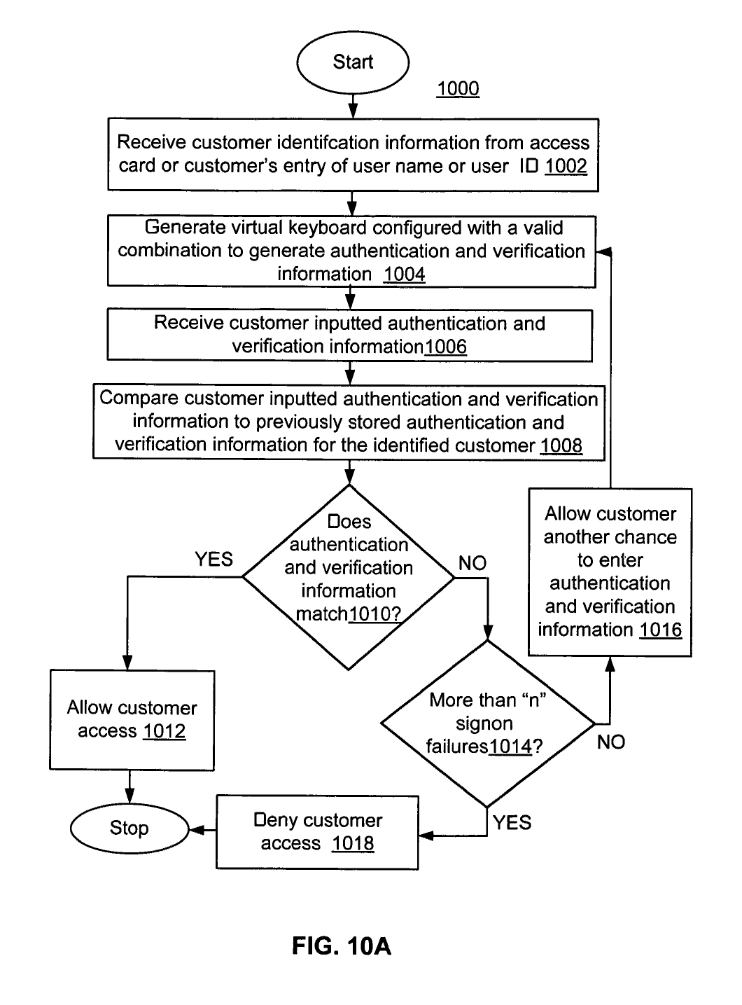

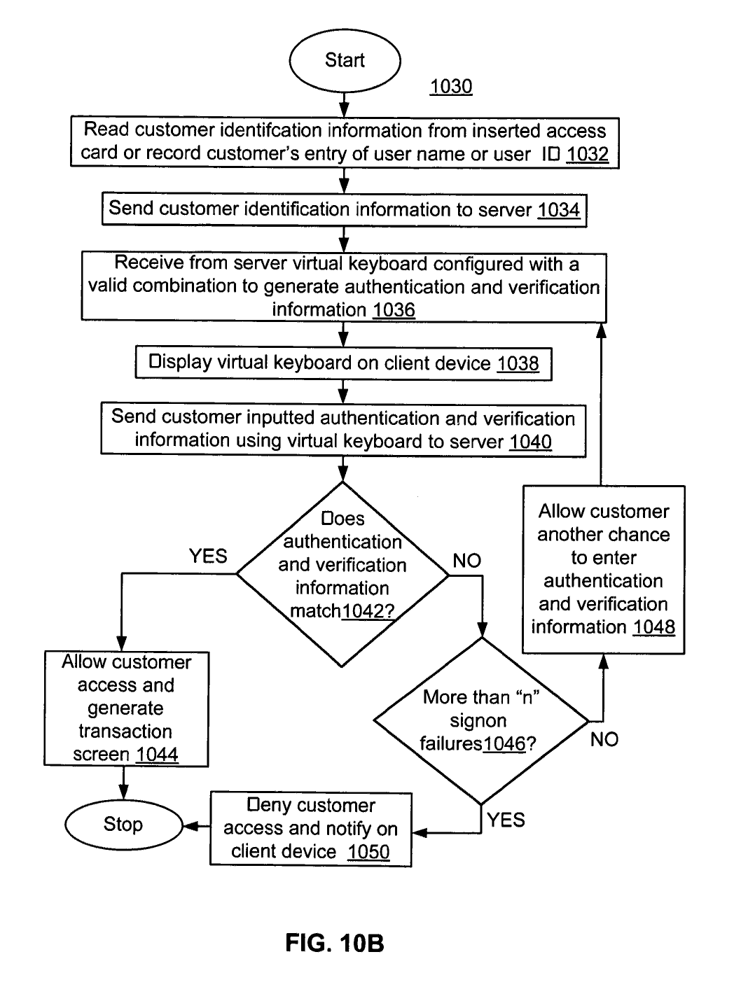

FIG. 10A is a flowchart of an example of a server side method 1000 for implementing UIs according to an embodiment. In optional step 1002, a server or terminal device for conducting a transaction, which may provide access to information or that determines whether to allow entry to a facility, receives a customer's identification information by reading the customer's access card with encoded identity and account information, or receives the customer's identity information directly from the customer's input of a user name and/or user ID. In step 1004, optionally in response to receiving the customer's identification, information for generating a UI on the user's device is sent to the user's device or at the service terminal with a valid combination to generate authentication and verification information through the customer's interaction with the UI, where the UI is based on stored authentication and verification information. In step 1006, the customer inputted authentication and verification information is received by the server and terminal. In step 1008, the customer inputted authentication and verification information is compared to previously stored authentication and verification information for the identified customer. In step 1010, if the customer inputted authentication and verification information matches the previously stored authentication and verification information (step 1010 is YES), then the customer is granted access in step 1012. In step 1010, if the customer inputted authentication and verification information does not match the previously stored authentication and verification information (step 1010 is NO), and there have not been more than “n” (where n is a user defined number) failed sign-on failures (step 1014 is NO), then the customer is granted another chance to try and re-authenticate and verify their identity (step 1016) through a new reconfigured UI (step 1004). If there have been more than “n” failed signon attempts (step 1014 is YES), then the customer is denied access in step 1018.

In at least one embodiment, each of the steps of method 1000 is a distinct step. In another embodiment, although depicted as distinct steps in FIG. 10, step 1002-1018 may not be distinct steps. In at least one embodiment, method 1000 may not have all of the above steps and/or may have other steps in addition to or instead of those listed above. The steps of method 1000 may be performed in another order. Subsets of the steps listed above as part of method 1000 may be used to form their own method.

FIG. 10B is a flowchart of an example of a client side method 1030 for implementing UIs according to an embodiment. In optional step 1032, a user's identification information is read from an inserted access card or obtained from the user's entry of a user name or user ID. In step 1034, optionally the customer's identification information is sent to a server. In step 1036 a version of an embodiment of UI as described above in FIGS. 1-9 is received at the client device from the server, where the UI has a valid combination of input keys and related entry values to generate authentication and verification information through the customer's interaction with the UI. In step 1038, the UI is displayed on the client device. In step 1040, the user inputted authentication and verification from the UI is sent to the server to be compared to previously stored authentication and verification information for the identified customer. In step 1042, if the customer inputted authentication and verification information matches the previously stored authentication and verification information at the server (step 1042 is YES), then the client device is granted access in step 1044 and a transaction screen is generated. In step 1042, if the customer inputted authentication and verification information does not match the previously stored authentication and verification information at the server (step 1042 is NO), and there have not been more than “n” (where n is a user defined number) failed signon failures (step 1046 is NO), then the customer is granted another chance to try and re- authenticate and verify their identity (step 1048) through a new reconfigured UI received from the server (step 1036). If there have been more than “n” failed signon attempts (step 1046 is YES), then the customer is denied access in step 1050 and notified on their client device.

In at least one embodiment, each of the steps of method 1030 is a distinct step. In another embodiment, although depicted as distinct steps in FIG. 10, step 1032-1050 may not be distinct steps. In at least one embodiment, method 1030 may not have all of the above steps and/or may have other steps in addition to or instead of those listed above. The steps of method 1030 may be performed in another order. Subsets of the steps listed above as part of method 1030 may be used to form their own method.

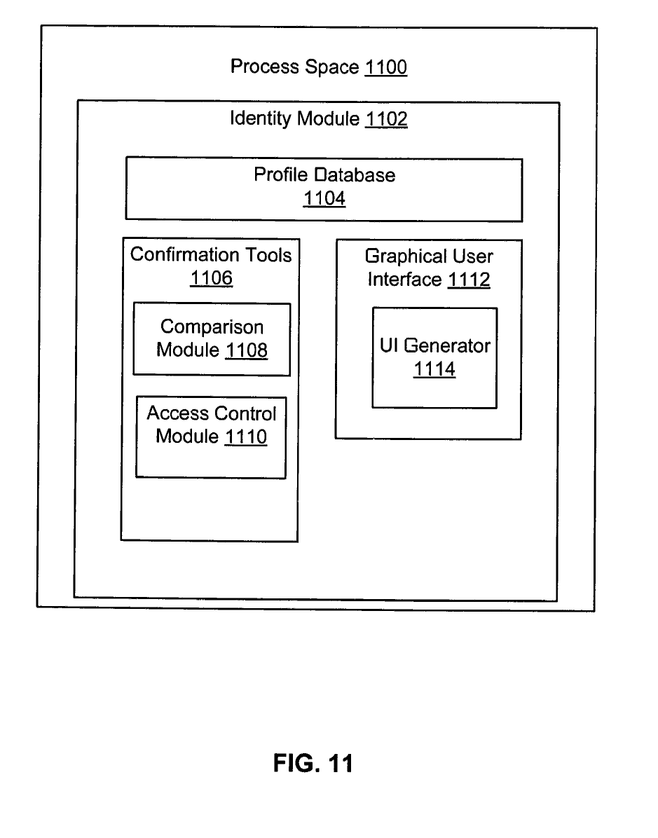

FIG. 11 is a block diagram of an embodiment of process space 1100. Process space 1100 may include identity module 1102, profile database 1104, confirmation tools 1106, comparison module 1108, access control module 1110, graphical user interface (GUI) 1112, and UI generator 1114. In other embodiments, process space 1100 may not have all of the elements listed and/or may have other elements instead of or in addition to those listed.

Process space 1100 is the portion of the system where various programs for the verification and authentication of users through the use of a UI reside. The identity module within the process space 1100 is responsible for maintaining the integrity of a system by controlling access to the system. The profile database 1104 contains the profile records of authorized users including, for example, user name, user ID, passwords, PIN, and/or other authorization information and/or codes. The confirmation tools 1106 utilizes the profile database 1104 to verify that a user may access system information or carryout transactions. The confirmation tools 1106 utilize a customer's identification information (that are either read from the customer's access card with encoded identity and account information, and/or obtained directly from the customer's input) to obtain previously stored authentication and verification information from the profile database 1104. The confirmation tools 1106 then works with the GUI 1112 and the UI generator 1114 to provide a UI with a valid combination or relationships between mapping values and entry keys (both virtual or physical keys) to generate authentication and verification inputs. The comparison module 1108 compares the authentication and verification inputs obtained from the user of the generated UI to the stored authentication and verification information. If the authentication and verification inputs match the stored authentication and verification information, the access control module 1110 grants the customer access to the system to obtain information, conduct transactions, and/or obtain entry to a facility.

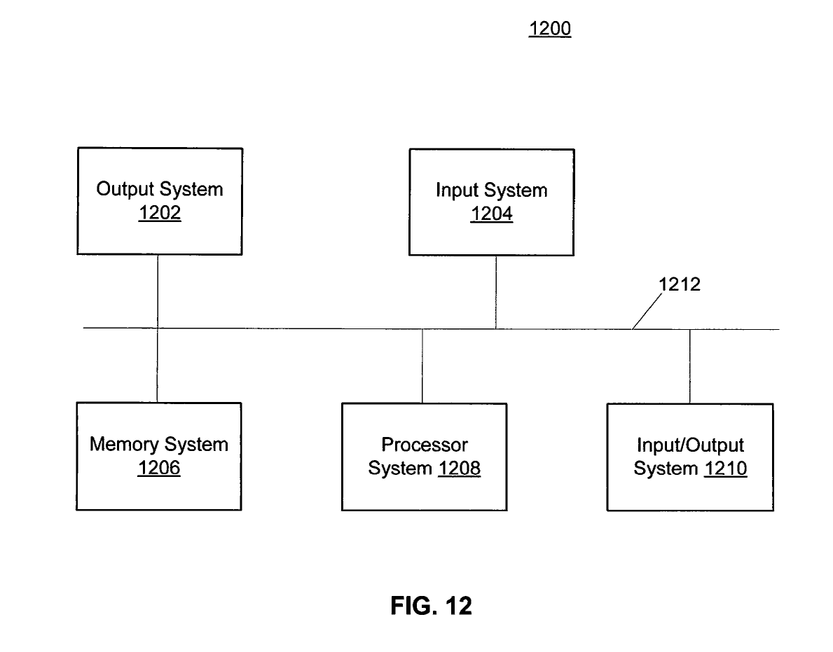

FIG. 12 shows a block diagram of an embodiment of a communication device 1200, which may be a user device or a server. The communication device may include output system 1202, input system 1204, memory system 1206, processor system 1208, communications system 1212, and input/output device 1210.

Console 1200 is an example of a communication device that may be used for implementing embodiments of a UI. Console 1200 may be a mobile internet appliance, such as a mobile phone, notepad, personal computer, server, laptop, or another internet appliance. In other embodiment, console 1200 may be an internet appliance that is not mobile. The server that serves the webpage or GUI having the UI may also be represented by a device similar to console 1200.

Output system 1202 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. Output system 1202 may include an antenna (e.g., if console 1200 is a mobile device) and/or a transmitter (e.g., if console 1200 is a mobile device).

Input system 1204 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. Input system 1204 may include an antenna (e.g., if console 1200 is a mobile device) and/or a receiver (e.g., if console 1200 is a mobile device).

Memory system 1206 may include, for example, any one of, some of, any combination of, or all of a long term storage system, such as a hard drive; a short term storage system, such as random access memory; a removable storage system, such as a floppy drive or a removable drive; and/or flash memory. Memory system 1206 may include one or more machine readable mediums that may store a variety of different types of information. The term machine-readable medium is used to refer to any non-transient medium capable carrying information that is readable by a machine. One example of a machine-readable medium is a computer-readable medium. Another example of a machine-readable medium is paper having holes that are detected that trigger different mechanical, electrical, and/or logic responses. Memory 1206 may store machine instructions for serving webpages having the interfaces of the embodiments of FIGS. 1-9 and/or for authenticating a user's input information. Memory system 1206 may store user information and include process space 1100.

Processor system 1208 may include any one of, some of, any combination of, or all of multiple parallel processors, a single processor, a system of processors having one or more central processors and/or one or more specialized processors dedicated to specific tasks. Also, processor system 1208 may include one or more Digital Signal Processors (DSPs) in addition to or in place of one or more Central Processing Units (CPUs) and/or may have one or more digital signal processing programs that run on one or more CPUs. Processor 1208 may carry out the machine instructions implementing the methods of FIGS. 10A and 10B, and FIG. 11 for generating UIs, legends for mapping PIN values to virtual and/or physical keyboards, keypads, and/or other input devices.

Communications system 1212 communicatively links output system 1202, input system 1204, memory system 1206, processor system 1208, and/or input/output system 1210 to each other. Communications system 1212 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 1210 may include devices that have the dual function as input and output devices. For example, input/output system 1210 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 1210 is optional, and may be used in addition to or in place of output system 1202 and/or input device 1204.

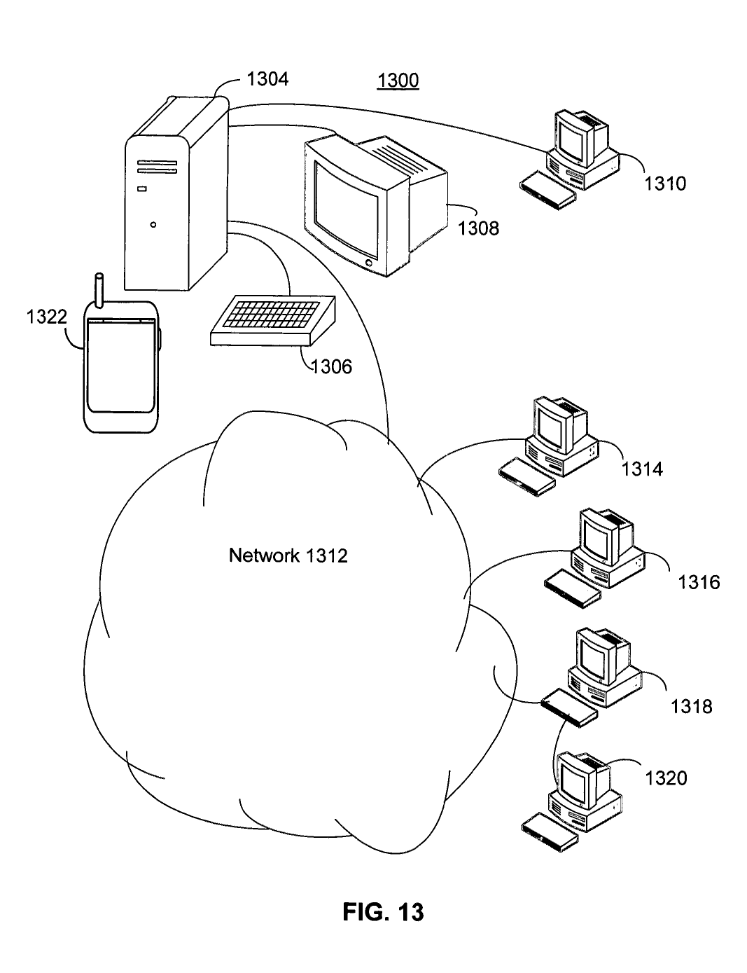

FIG. 13 illustrates a block diagram of an embodiment of a system 1300 for implementing embodiments of UI access systems. The system 1300 includes a server system 1304, an input system 1306, an output system 1308, a plurality of client systems 1310, 1314, 1316, 1318 and 1320, a communications network 1312 and a hand-held device 1322. In other embodiments, the system 1300 may include additional components and/or may not include all of the components listed above.

Server system 1304 may include one or more servers. Server system 1304 may be the property of the right holder and/or user/agent. Input system 1306 system may be used for entering input into server system 1304, and may include any one of, some of, any combination of, or all of a keyboard system, a mouse system, a track ball system, a track pad system, buttons on a handheld system, a scanner system, a wireless receiver, a microphone system, a connection to a sound system, and/or a connection and/or an interface system to a computer system, intranet, and/or the Internet (e.g., IrDA, USB), for example.

Output system 1308 may be used for receiving output from server system 1304, and may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, intranet, and/or the Internet, for example.

The system 1300 illustrates some of the variations of the manners of connecting to the server system 1304, which may be information providing site (not shown).

Server system 1304 may be directly connected and/or wirelessly connected to the plurality of client systems 1310, 1314, 1316, 1318 and 1320 and are connected via the communications network 1312. Client systems 1310, 1314, 1316, 1318 and 1320 may belong to participants of the embodiments of UI access as described in this specification. Client system 1320 may be connected to server system 1304 via client system 1318. The communications network 1312 may be any one of, or any combination of, one or more Local Area Networks (LANs), Wide Area Networks (WANs), wireless networks, telephone networks, the Internet and/or other networks. The communications network 1312 may include one or more wireless portals. The client systems 1310, 1314, 1316, 1318 and 1320 are any system that an end user may use to access the server system 1304. For example, the client systems 1310, 1314, 1316, 1318 and 1320 may be personal computers, workstations, laptop computers, game consoles, handheld network enabled audio/video players and/or any other network appliance.

The client system 1320 accesses the server system 1304 via the combination of the communications network 1312 and another system, which in this example is client system 1318. The client system 1322 is an example of a handheld wireless device, such as a mobile phone or a handheld network enabled audio/music player, which may also be used for accessing network content. In another embodiment, any combinations of client systems 1310, 1314, 1316, 1318, 1320 and/or 1322 may include a GPS system.

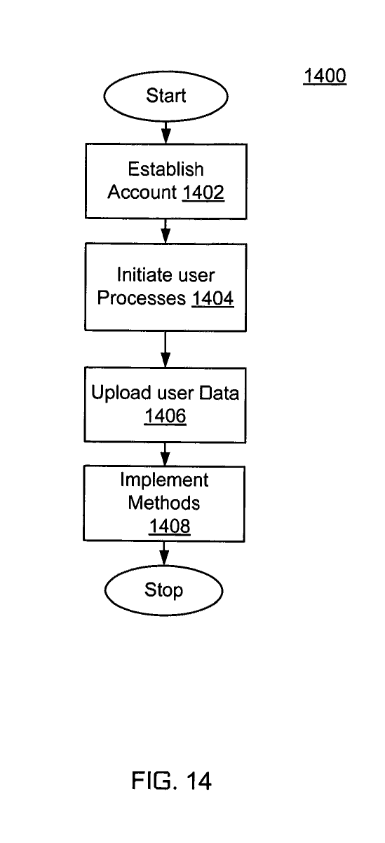

FIG. 14 shows a flowchart of an example of a method 1400 of using environment 1100 (FIG. 11). In step 1402, identity module 1102 establishes an account for a user. In step 1104, one or more process spaces 1100 are initiated on behalf of a user, which may also involve setting aside space for user data in profile database 1104. Step 1404 may also involve modifying application metadata to accommodate process space 1100. In step 1406, process space 1100 uploads data. In step 1406, one or more data objects are added to profile database 1104 where the uploaded data is stored such as the user's PIN or authentication and verification information. In step 1408, methods and the code for generating UIs for conducting secure transactions in environments associated with FIGS. 11-13 may be implemented. In an embodiment, each of the steps of method 1400 is a distinct step. In another embodiment, although depicted as distinct steps in FIG. 14, steps 1402-1408 may not be distinct steps. In other embodiments, method 1400 may not have all of the above steps and/or may have other steps in addition to or instead of those listed above. The steps of method 1400 may be performed in another order. Subsets of the steps listed above as part of method 1400 may be used to form their own method.

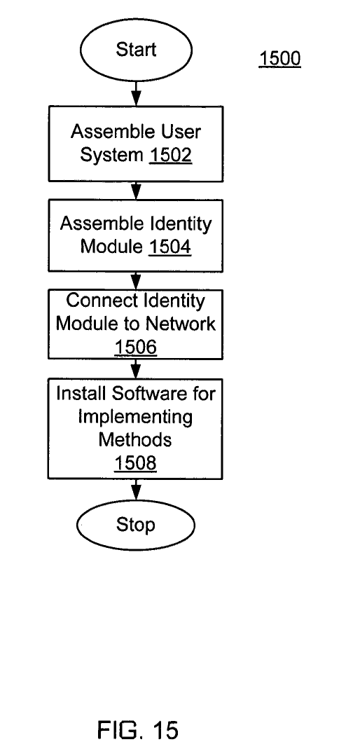

FIG. 15 illustrates a flowchart of a method of making the environment of FIGS. 11-13. In step 1502, a user system (FIGS. 11-13) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 1504, identity module 1102 (FIG. 11) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling Identity Module 1102 may include installing profile database 1104, confirmation tools 1106, and graphical user interface 1112.

In step 1506, identity module 1102 is communicatively coupled to network 1312 (FIG. 13) allowing process space 1100 to communicate with users terminals and devices (FIGS. 12 and 13). In step 1508, one or more instructions may be installed in process space 1100 (e.g., the instructions may be installed on one or more machine readable media, such as computer readable media, therein) and/or system 1100 is otherwise configured for performing the steps of methods and generating UIs. For example, as part of step 1508, one or more instructions may be entered into the memory of 1206 (FIG. 12) for creating UIs. In an embodiment, each of the steps of method 1500 is a distinct step. In another embodiment, although depicted as distinct steps in FIG. 7, steps 1502-1508 may not be distinct steps. In other embodiments, method 1500 may not have all of the above steps and/or may have other steps in addition to or instead of those listed above. The steps of method 1500 may be performed in another order. Subsets of the steps listed above as part of method 1500 may be used to form their own method.

### Extensions or Alternatives

In an embodiment, instead of being a sequence of numbers on the keyboard and the mapping providing alternative keys that may be pressed instead of the actual PIN, the PIN is the sequence of colors, shapes, symbols, mathematical formulas, and/or results of mathematical computations instead of a sequence of numbers, and for each entry the user selects any of the keys that is mapped to the current desired value (e.g., the color, shape, or mathematical formula) for that entry. A few examples of a PIN may be red, blue green, white; triangle square, octagon, circle; or any math problem whose answer is 2, any math problem whose answer is 4, any math problem whose answer is 7, any math problem whose answer is 1. In an embodiment, the mapping between the keys or other input to the values of the code is changed periodically. For example, the mapping may be changed every usage, after a fixed number of usages, at fixed intervals of time, according to a predetermined pattern of usages and/or time intervals, according to a randomly (e.g., a determined by a random number generator and/or other algorithm) selected sequence or pattern of time intervals and/or number of usages. Thus, by changing the mapping, if the PIN is a sequence of numbers on the keyboard and the mapping provides alternative keys that may be pressed instead of the actual PIN, the alternative key that may be pressed instead of the actual PIN is change periodically. Similarly, if the PIN is the sequence of values on the display, and if the PIN is a sequence of colors, shapes, symbols, mathematical formulas, and/or results of mathematical computations instead of a sequence of numbers, by changing the mapping to the input device, all of the acceptable input entries may be changed by changing the mapping, such that none of the previous acceptable inputs from the input device are currently actable for the same value of the PIN. In an alternative embodiment, a device may be built having a physical interface with physical keys that resemble entry keys 104A-104E, 204A-204E, 304A-304D, 404A-404E, 504A-504E, 604A-604E, and 704A-704E instead or in addition to providing virtual entry keys 104A-104E, 204A-204E, 304A-304D, 404A-404E, 504A-504E, 604A-604E, and 704A-704E, Although only UI 700 of FIG. 7 has a cancel button, any of the embodiments of this specification may have a cancel button.

In an alternative embodiment, the coloring of mapping values 102A-102J creates a mapping that indicates alternative inputs that are treated as the same value and mapped to one another. Thus in the example of FIG. 1, the keyboard inputs 1 and 7 are treated as the same value, the keyboard inputs 2 and 6 are treated as the same value, the keyboard inputs 3 and 8 are treated as the same value, the keyboard inputs 4 and 9 are treated as the same value, and the keyboard inputs 5 and 0 are treated as the same value. Thus, if for example, the user's PIN 0314, the user may choose to enter 5789 or any combination of the actual PIN values and the alternative acceptable values indicated by mapping values 102A-J. This way, the user may change the input used as the PIN, which may confuse someone attempting to determine the PIN based on the keyboard entries or the entries of another input device. In an embodiment, instead of (or in addition to) using entry keys 104A-104F, keyboard entries or selecting one of mapping values 102A-102J may be entered. Alternatively, the sequence of entry keys 104A-104F, may inform the user what sequence of mapping values 102A-102J are acceptable to select.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

While the method and system for UIs have been described by way of example and in terms of the specific embodiments, it is to be understood that the method and system for trading tournaments is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method of securely accessing electronic systems comprising:
sending to a user device information for generating a representation of a mapping between password values and entry keys, the mapping maps a set of at least two password values to only one entry key, the information directing the user device to display each of the at least two password values at locations separated from each other by one or more other password values, and locating the password values on the user device display without a spatial relationship to the entry keys;
receiving from a user device a sequence of inputs corresponding to a sequence of selections of the entry keys from an input device of the user machine;
determining whether the input received can be mapped to a password value of a stored password; and
determining whether to grant access based on the whether the input can be mapped to a password that matches the stored password.

2. The method of claim 1, where the mapping is through an association between the password values and the entry keys, the association based on color assignments.

3. The method of claim 2, further comprising displaying each of a plurality of candidates for the password values in one of a plurality of colors with on of the candidates for the password values assigned to a specific color from the plurality of colors that is the color assigned to another of the plurality of candidates for the password values; and
displaying the entry keys, each entry key being assigned a unique color from the plurality of colors.

4. The method of claim 1, where the mapping is through an association between the password values and the entry keys, the association based on shape assignments.

5. The method of claim 4, further comprising displaying each of a plurality of candidates for the password values in one of a plurality of shapes with at least one of the plurality of candidates for the password values being assigned to a specific shape from the plurality of shapes, and at least an of the plurality of candidates for the password values being assigned to specific shape; and
displaying the entry keys, each of the entry keys being assigned a unique shape from the plurality of shapes.

6. The method of claim 1, where the mapping is through an association between the password values and the entry keys, the association based on color and shape assignments.

7. The method of claim 6, further comprising:
displaying each of a plurality of candidates for the password values in one of a plurality of shapes that has one of a plurality of colors, the plurality shapes having a one-to-one correspondence with the plurality of colors, at least one of the plurality of candidates for the password values being assigned to a specific shape selected from the plurality of shapes and a specific color selected from the plurality of colors, according to the one-to-one correspondence, and at least another of the plurality of candidates for the password values being assigned to the specific shape and the specific color; and
displaying the entry keys, each of the entry keys being assigned a unique shape from the plurality of shapes and a unique color from the plurality of colors according to the one-to-one correspondence.

8. The method of claim 1, where the mapping is through an association between the password values and the entry keys, the association based on logical relationships.

9. The method of claim 8, further comprising where one or more of the password values have a specific characteristic assigned from a set of characteristics, and each of the entry keys are each assigned a unique characteristic from the set of characteristics such that one or more of the password values are logically related to each of the entry values based on the characteristics.

10. The method of claim 8, where the logical relationships are based on the matching of a series of symbols assigned to the password values and the entry keys.

11. The method of claim 10, where each of the password values are displayed with one of a plurality of symbols, with one or more of the password values assigned to a specific symbol from the plurality of symbols; and
the entry keys are each assigned a unique symbol from the plurality of symbols.

12. The method of claim 8, where the logical relationships are based on the solving of equations assigned to the password values to determine a corresponding choice from the entry keys.

13. The method of claim 12, further comprising displaying plurality of candidates for the password values and a mathematical equation in association with each of the plurality of candidates for the password values, the solving of the mathematical equation providing a solution value from a set of values, at least one of the candidates for the password values being displayed in association with an equation that yields a solution that is identical to a solution of another equation that is displayed in association with another candidate for the password value;
where the entry keys are each assigned a unique solution value from the set of values; and
where matching of solution values assigned to the candidates for the password values and entry keys are the logical relationship.

14. The method of claim 8, where the logical relationships are based on associating words assigned to the password values to categories assigned to the entry keys.

15. The method of claim 14, where at least two words belong to at least one category and a specific category is assigned to each of the entry keys.

16. The method of claim 1, the generating of a representation of a mapping between password values and entry keys is determined based on the stored password.

17. The method of claim 1, where the generating of a representation of a mapping between password values and entry keys is reconfigured for each session.

18. The method of claim 1, further comprising receiving identification information by keyed entry of a user name or a user ID on the input device.

19. A non-transitory machine-readable medium carrying one or more instructions for securely accessing electronic systems, which when executed cause a method to be carried out, the method comprising:
sending to a user device information for generating a representation of a mapping between password values and entry keys, the mapping maps a set of at least two password values to only one entry key, the information directing the user device to display each of the at least two password values at locations separated from each other by one or more other password values, and locating the password values on the user device display without a spatial relationship to the entry keys;
receiving from a user device a sequence of inputs corresponding to a sequence of selections of the entry keys from an input device of the user machine;
determining whether the input received can be mapped to a password value of a stored password; and
determining whether to grant access based on the whether the input can be mapped to a password that matches the stored password.

20. A computer network configured for providing secure access to network functions and data access, the computer network comprising:
one or more servers each having a processor system including at least one processor; and
a memory system with a machine readable medium comprising storage for user identification and verification information and one or more sequences of instructions stored thereon which, when executed, cause a method to be carried out, the method comprising:
sending to a user device information for generating a representation of a mapping between password values and entry keys, the mapping maps a set of at least two password values to only one entry key, the information directing the user device to display each of the at least two password values at locations separated from each other by one or more other password values, and locating the password values on the user device display without a spatial relationship to the entry keys;
receiving from a user device a sequence of inputs corresponding to a sequence of selections of the entry keys from an input device of the user machine;
determining whether the input received can be mapped to a password value of a stored password; and
determining whether to grant access based on the whether the input can be mapped to a password that matches the stored password.
